(19) United States
(12) Patent Application Publication
(10) Pub. No.: US 2002/0064983 A1
(43) Pub. Date: May 30, 2002

(54) Apparatus and method for remotely unplugging electrical plugs

(76) Inventor: Kenneth C. Patey, Bountiful, UT (US)

Correspondence Address: MADSON & METCALF, GATEWAY TOWER WEST, SUITE 900, 15 WEST SOUTH TEMPLE, SALT LAKE CITY, UT, 84101

(21) Appl. No.: 09/726,872

(22) Filed: Nov. 30, 2000

Related U.S. Application Data
(60) Provisional application No. 60/211,361, filed on Jun. 13, 2000.

(51) Int. Cl. H01R 13/62

(52) U.S. Cl. 439/152

(57) ABSTRACT

An apparatus and method for remotely unplugging an electrical device is disclosed. The apparatus may include a connection member with prongs in one end, suitable for engaging a standard wall outlet, and a receiving socket in the opposite end for receiving a standard electrical plug. A pressure member may be movably attached to the connection member to push the connection member away from an electrical outlet, thereby withdrawing the prongs and effectively unplugging the electrical device. The pressure member may be driven by a spring that is held in a compressed configuration by a locking member. The locking member may, in turn, be unlocked by a mechanical or electrical actuator. For example, the actuator may be a flexible connector attached to the power cord of the electrical device, such that pulling on the cord results in unlocking the locking member. Alternatively, the actuator may be a solenoid driven by power through the apparatus. The solenoid may then be activated by a remote switch either wired to the solenoid, or to a transmitter that emits a wireless analog or digital signal received by a receiver connected to the solenoid. The solenoid may also be activated by a current or voltage sensor within the apparatus, so that the apparatus ejects when a user toggles the on/off switch of the electrical device repeatedly, or when the current through the apparatus is higher than advisable for the electrical device.

### RELATED U.S. APPLICATIONS

This application claims the benefit of U.S. Provisional Application No. 60/211,361 filed Jun. 13, 2000 and entitled APPARATUS AND METHOD FOR REMOTELY UNPLUGGING ELECTRICAL PLUGS, which is incorporated herein by reference.

### BACKGROUND OF THE INVENTION

1. The Field of the Invention

The present invention relates to an apparatus and method for enhancing the safety and convenience of electrical appliances. More specifically, the present invention provides a novel apparatus and method for remotely unplugging an electrical plug from an electrical outlet.

2. The Relevant Technology

Mobile electrical devices have been greatly helpful in easing the burden of performing common tasks, such as vacuuming, buffing, sanding polishing, edging, nailing, and the like. Such devices often have a lengthy power cord so that a user can use the device at a substantial distance away from the electrical outlet from which the device receives power. However, many applications for which such devices are commonly used, such as buffing a large floor, still require a user to periodically unplug the device and plug it in at a new location. The janitorial, cleaning, and construction industries are particularly burdened by the need to return to an outlet, unplug a device, move the plug to a new outlet, and return to the location of the electrical device before work can continue. Consequently, considerable amounts of extra time and energy are expended.

As a result of this inconvenience, many users utilize potentially unsafe methods to unplug the electrical device, such as shaking, spinning, or simply jerking the plug out of the wall by grasping the cord. These methods have a number of consequences, including damage to the cord and plug of the electrical device, damage to the electrical outlet, and damage to structures connected to the outlet, for example, the electric circuit to which the outlet is connected. Furthermore, damaged electrical components may cause injury or even fatalities by electrocution, or may cause dangerous electrical fires.

Additionally, many users do not realize when they are approaching the extent of the cord. Thus, they accidentally pull on the cord as they continue to use the electrical device. The result is similar to that obtained by intentionally pulling on the cord to pull the plug out: the plug and/or outlet may be damaged, and may cause further injury or property damage. Tight bending of the cord, as may occur when a user pulls the cord from one side of the outlet, is especially likely to cause damage.

Other known systems and methods designed to facilitate the process of moving a plug from one outlet to another have often proven to be expensive or unworkable, for a number of reasons. For example, many prior art devices designed to remotely unplug an electrical plug must be integrated with a single electrical device. The electrical device must then be specially manufactured with a remotely unpluggable plug. Such an unplugging device cannot be retrofitted to an existing electrical device, and cannot be moved from one electrical device to another. Consequently, such unplugging devices are severely limited in application and market penetration capability.

Some known devices permit a user to unplug the device only under somewhat limited circumstances. For example, certain known devices are designed to unplug themselves only when a user pulls the power cord sideways, or in a certain direction. Such a requirement presupposes that the user will be in a position to pull the cord in the required direction. If a user is utilizing the electrical device straight outward from the outlet, he or she must then move sideways or approach the plug to effect remote unplugging. A user could just as well return to the outlet and unplug the plug manually.

Yet other known devices are bulky, unwieldy, or redundant in design. For example, remote unplugging devices that include an entire extension cord are needlessly repetitive. Even if the extension cord device has prongs at one end and a switch to eject the prongs at the other, the power cord of the electrical device must be maintained coiled or gathered at the electrical device so that the switch of the unplugging device is operable from the vicinity of the electrical device. A user is effectively forced to purchase and use the extension cord provided by the unplugging device, leaving the cord of the electrical device unused.

Accordingly, a need exists for a safe and convenient apparatus and method for unplugging devices from an electrical outlet. The apparatus and method should function remotely, e.g., be operable from the electrical device. Preferably, the apparatus should not require an independent power source, and should be retrofittable so that is can be adapted to a wide variety of electrical devices with a minimum of modification. Moreover, the apparatus should preferably be ejectable from virtually any location within the range of the cord, so that a user does not have to move to any different location to unplug the apparatus. Furthermore, the apparatus should be inexpensive, compact, and durable.

### OBJECTS AND BRIEF SUMMARY OF THE INVENTION

The apparatus of the present invention has been developed in response to the present state of the art, and in particular, in response to the problems and needs in the art that have not yet been fully solved by currently available electrical plugs. Thus, it is an overall objective of the present invention to provide an apparatus and method for remotely unplugging electrical devices.

To achieve the foregoing objects, and in accordance with the invention as embodied and broadly described herein in the preferred embodiment, a plug extension device is provided. In certain embodiments, the plug extension device comprises a connection member, which may take the form of a movable central core, and a pressure member, which may be a tubular housing disposed around the central core. The core may have prongs at one end, suitable for engagement in a standard wall outlet, or socket. The core may have a receiving socket at the other end, suitable for receiving a plug from the electrical device. Through motion of the core within the housing, the prongs may be extended to engage the outlet or retracted to disengage from the outlet, thereby unplugging the apparatus and the electrical device.

The plug extension device furthermore comprises a spring selectively maintained in a compressed state by a locking member. When activated at the remote location, an actuator applies a comparatively small force to the locking member, the locking member releases the spring to cause the core to move within the housing, in a direction away from the outlet, to withdraw the prongs from the outlet. Once disengaged, a user may cock the apparatus by pressing the core within the housing to compress the spring until locking occurs. The apparatus may then be plugged in again and remotely unplugged, in the same fashion.

The actuator may take a number of different forms, according to the various embodiments of the invention. In one embodiment, the actuator comprises a flexible connector, such as a cord, wire, or chain, connected to the locking member and the power cord of the apparatus. The flexible connector is attached so that a comparatively longer length of the power cord remains between the attachment point and the apparatus. As a result, tugging motion on the cord, beyond the attachment point, pulls on the flexible connector. Tension on the connector then pulls the locking member into an unlocked state, thereby releasing the spring. Thus, ejection of the apparatus is accomplished by purely mechanical implements.

In one alternative embodiment, the actuator takes the form of a solenoid. The solenoid may be of a linear type, i.e., with a linear force output that provides the force necessary to unlock the locking member. The solenoid may be connected to the prongs to receive power directly from the outlet. The solenoid may be activated by any number of methods.

A switch may be positioned at a remote location, such as at the electrical device, and wired to the solenoid. Wiring may be accomplished by running wire from the switch to the solenoid, along the power cord. The wiring for the switch may be wrapped around the power cord and/or attached by any suitable attachment method.

Alternatively, the solenoid may be activated wirelessly. The switch at the remote location may then be connected to a transmitter, such that operation of the switch causes the transmitter to transmit an electromagnetic signal. The signal may, for example, be an analog, radio frequency signal. In the alternative, a digital signal may be used. A receiver wired to the solenoid may then activate the solenoid to unlock the spring and eject the apparatus from the outlet.

In other embodiments, the apparatus may effectively measure the voltage or current drawn by the electrical device and initiate ejection when preset patterns are detected. For example, the apparatus may be configured to initiate ejection when the current flow is stopped, restarted, and stopped again in rapid succession. Thus, a user may simply turn the electrical device off, on, and off again to eject the apparatus. Alternatively, the device may be configured to act as a circuit breaker and eject the apparatus when the current through the apparatus exceeds a preset limit. Thus, the apparatus may act as a customized circuit breaker for the electrical device.

Thus, through the use of the apparatus, a user need not return to the outlet to unplug the electrical device, but may unplug it remotely, by activating a switch, tugging on the power cord, or simply toggling the power switch of the electrical device repeatedly. No modification of the electrical device is needed, and the plug extension device may be added to any electrical device and used successfully, without the use of a separate power source. A user may initiate ejection from virtually any location, rather than just those locations laterally displaced from the outlet. Furthermore, the apparatus is compact and durable, and may therefore be rapidly and inexpensively manufactured and distributed.

These and other objects, features, and advantages of the present invention will become more fully apparent from the following description and appended claims, or may be learned by the practice of the invention as set forth hereinafter.

### BRIEF DESCRIPTION OF THE DRAWINGS

In order that the manner in which the above-recited and other advantages and objects of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a perspective view of one mechanically-triggered embodiment of an apparatus according to the invention, in use to provide remotely removable power to an electrical device;

FIG. 2 is an exploded, perspective view of a connection member, or core, suitable for the apparatus of FIG. 1;

FIG. 3 is an exploded, perspective view of the apparatus of FIG. 1, including the connection member of FIG. 2;

FIG. 4 is a cross-sectioned, plan view of one embodiment of an apparatus according to the invention, in the uncocked configuration;

FIG. 5 is a cross-sectioned, plan view of the embodiment of FIG. 4, in the cocked configuration;

FIG. 6 is an exploded, perspective view of an alternative embodiment of an apparatus according to the invention, with a remote switch wired to the apparatus to electrically trigger disengagement from the outlet;

FIG. 7 is an exploded, perspective view of another alternative embodiment of an apparatus according to the invention, with a remote switch configured to send a wireless signal to the apparatus to electrically trigger disengagement from the outlet;

FIG. 8 is a perspective view of selected parts of yet another alternative embodiment of the invention, with a current measurement device configured to electrically trigger disengagement from the outlet in response to current changes through the apparatus; and

FIG. 9 is a perspective view of selected parts of yet another alternative embodiment of the invention, with a capacitor to store power for electrical disengagement.

### DETAILED DESCRIPTION OF THE PREFERRED EMBODIMENTS

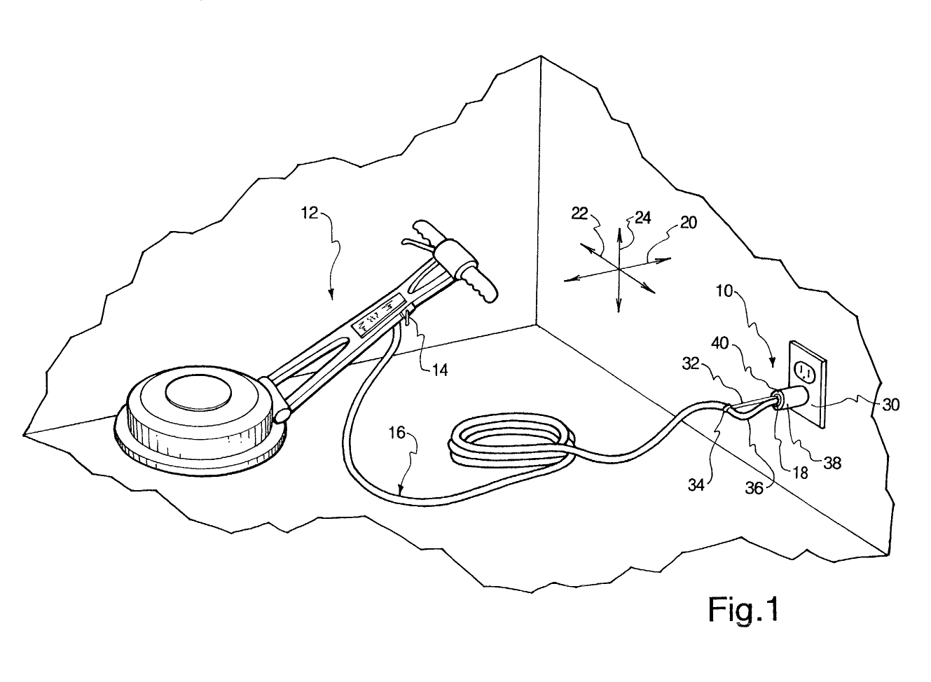

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 through 9, is not intended to limit the scope of the invention, as claimed, but is merely representative of presently preferred embodiments of the invention.

Referring to FIG. 1, one possible embodiment of an apparatus for remotely unplugging electrical plugs is depicted and designated 10. The apparatus 10 is depicted in conjunction with an electrical device 12. The apparatus 10 is usable with many different types of electrical devices, but is especially useful for electrical devices that are used over a large area, such as vacuum cleaners, buffers, sanders, trimmers, hedgers, construction equipment, and the like. In FIG. 1, the electrical device 12 is depicted as a buffer 12. The buffer 12 has a power switch 14 used to turn the buffer 12 on or off. Electricity is obtained through a cord 16 that terminates in a plug 18. The plug 18, in turn, is plugged in to the apparatus 10. For reference herein, a longitudinal direction 20, a lateral direction 22, and a transverse direction 24 may be oriented as shown with respect to the apparatus 10.

The plug 18 is preferably of a common type, designed to plug into a standard outlet 30. In the accompanying figures, the apparatus 10 is depicted as configured for use with a standard, U.S. 110 Volt outlet 30; however, those skilled in the art will recognize that the apparatus 10 may readily be adapted for 220 Volt U.S. outlets or foreign outlets having a wide variety of prong configurations and electrical specifications. The outlet 30 need not be mounted on a structural wall, as depicted, but may be inside a vehicle, or located in a more open setting.

In the following description, “forward” refers to features comparatively nearer the outlet 30. Similarly, “rearward” refers to features further from the outlet 30.

According to the embodiment of FIG. 1, the apparatus 10 comprises a flexible connector 32 constructed of string, twine, chain links, or some other flexible arrangement. The flexible connector 32 is connected to the cord 16 by an anchoring device 34, such as a noose, a pliable constricting plastic connector, or the like. Preferably, the flexible connector 32 has a length ranging from about 6 inches to about 24 inches between the apparatus 10 and the anchoring device 34. The anchoring device 34 is positioned on the cord 16 to leave a portion 36 of the cord somewhat longer than the flexible connector 32 between the anchoring device 34 and the plug 18.

In operation, when a user of the buffer 12 moves the buffer 12 so that the cord 16 is extended nearly to its limit, the user may simply grasp the cord 16 near the buffer 12 and tug somewhat gently. The tension in the cord 16 is transferred to the flexible connector 32 by operation of the anchoring device 34. The flexible connector 32 is connected to the apparatus 10 in such a manner that tension in the flexible connector 32 triggers operation of the apparatus 10.

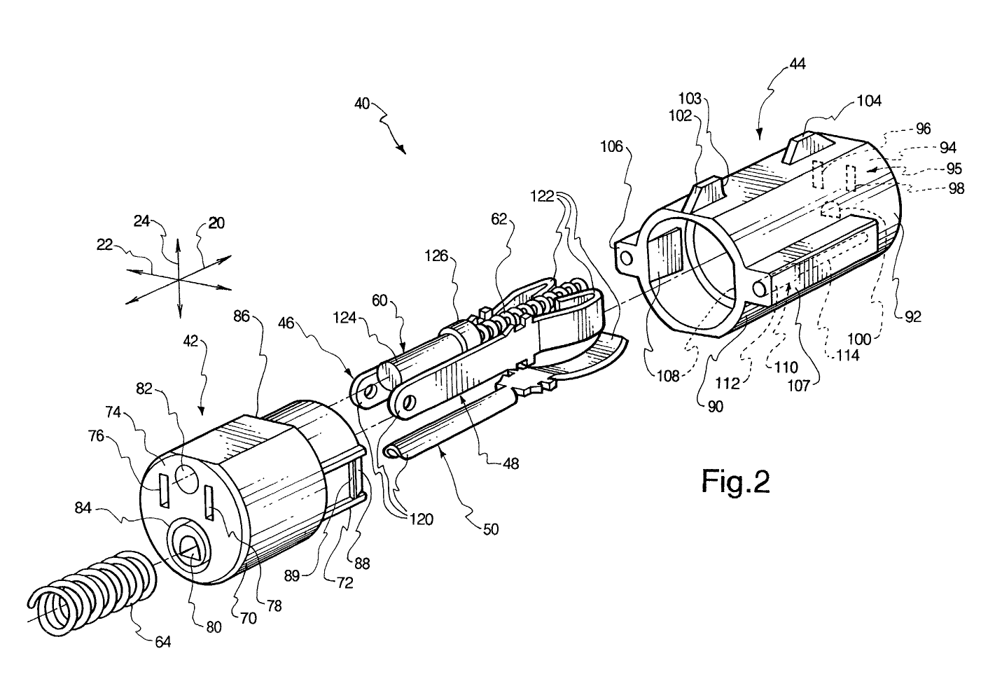

When the apparatus 10 is triggered, a pressure member 38 of the apparatus 10 remains relatively stationary while a connection member 40 is drawn outward from the outlet 30, thereby causing the apparatus 10 to separate, or “disengage,” from the outlet 30. The plug 18 is connected to the connection member 40, and remains connected after disengagement of the apparatus 10 from the outlet 30. The user can then reel in the cord 16, along with the apparatus 10, and plug the apparatus 10 into another outlet (not shown). The manner in which the apparatus 10 is triggered to disengage from the outlet 30 will be shown and described in further detail in connection with FIGS. 2 through 5.

The connection member 40 and the pressure member 38 may interact in a number of ways, including many different types of pivotal and translational attachment. The present invention envisions the attachment of the connection member 40 to the pressure member 38 in any way that enables the pressure member 38 to press against the outlet 30, while the connection member 40 moves away from the outlet 30 for electrical disconnection. Thus, the connection member 40 and the pressure member 38 may have a wide variety of configurations.

For example, the connection member 40 and the pressure member 38 may be disposed beside each other, in the lateral or transverse directions 22, 24, to slide relative to each other in the longitudinal direction 20. Alternatively, the pressure member 38 and the connection member 40 may be connected by a pivotal attachment such that the pressure member 38 rotates about the lateral or transverse axis 22, 24 to press against the outlet 30. As depicted in FIG. 1, the connection member 40 takes the form of a core 40 linearly slidable within the pressure member 38, which is then be configured as a housing 38 with a roughly annular shape. Thus, with reference to the configuration of FIG. 1, the pressure member 38 may be referred to as the housing 38, and the connection member 40 may be referred to as the core 40.

Preferably, the core 40 and the housing 38 are substantially rigid and compact so that they can be easily and inexpensively manufactured, transported, and assembled. “Substantially rigid” refers to a member with a material and geometry selected to give the member a definite undeformed shape. Thus, most polymers, metals, and ceramics, would be stiff enough to use for construction of the core 40 and the housing 38. However, typical elastomeric materials lack the rigidity to perform the functions carried out by the core 40 and the housing 38. Polymeric materials, or plastics, provide some advantages due to their light weight, low cost, and potential transparency.

“Substantially compact” refers to a device that can easily be carried by a user and plugged into the outlet 30 without extending from the outlet 30 far enough to cause inconvenience. Thus, the total length of the apparatus 10, is preferably a few inches or less. Therefore, the core 40 and the housing 38 are each preferably a few inches or less in length.

Referring to FIG. 2, an exploded view of one possible core 40 suitable for the apparatus 10 of FIG. 1 is depicted. The core 40 has a cap member 42 designed to face the outlet 30, and a receiving member 44 configured to receive the plug 18. The members 42, 44 may be constructed of any suitable material, such as a metal, ceramic, plastic, or composite. However, nonconductive, lightweight, and easily manufactured materials, such as plastics, are generally preferable.

The connection and receiving members 42, 44 are both at least partially hollow to contain the features necessary for conveying electricity from the outlet 30 to the plug 18. As depicted in FIG. 2, these features may include a hot prong 46, a common prong 48, and a ground prong 50, each of which corresponds to a similar prong of the plug 18. The prongs 46, 48, 50 will be engaged by the outlet 30 during operation of the apparatus 10.

Preferably, the core 40 also comprises features designed to urge the core 40 away from the outlet 30. Thus, the core 40 may be locked into position relative to the housing 38, and then simply unlocked to trigger disengagement of the apparatus 10. More specifically, the core 40 may have a nonconductive member 60, a first resilient member 62 and a second resilient member 64. The first and second resilient members 62, 64 may be configured as first and second springs 62, 64, respectively, as depicted in FIG. 2.

The cap member 42 has a first end 70, disposed toward the outlet 30, and a second end 72 located further from the outlet 30. A face 74 is disposed on the first end 70 and configured as a flat, substantially circular surface. A hot prong slot 76, a common prong slot 78, and a ground prong slot 80 are formed in the face 76 to permit passage of the hot prong 46, the common prong 48, and the ground prong 50, respectively. The slots 76, 78, 80 preferably extend clear through to the hollow interior of the cap member 42.

Additionally, the face 74 comprises a hole 82, above and between the hot and common slots 76, 78, through which the nonconductive member 60 may extend. Preferably, the hole 82 extends into the hollow interior of the cap member 42. The face 74 also comprises an annular hole 84, disposed around the ground prong slot 80, to receive the second spring 64. The annular hole 84 does not extend into the hollow interior, but terminates to provide a backing for the second spring 64.

The cap member 42 may have a shoulder 86 facing the receiving member 44, such that the shoulder 86 and receiving member 44 can be positioned and attached in abutting relation during assembly. Additionally, the cap member 42 may have one or more attachment features 88 configured to interface with the receiving member 44 to lock the cap member 42 and the receiving member 44 together. In FIG. 2, two receiving members 88 are depicted, each of which comprises a pliable tab with a perpendicular locking portion 89.

The receiving member 44 may similarly have a first end 90 and a second end 92. The second end 92 may have a face 94 configured to receive the plug 18. More specifically, the face 92 preferably comprises a receiving socket 95 configured to receive the plug 18 and to provide electrical communication between the plug 18 and the outlet 30. “Electrical communication” refers to the existence of a relatively low-resistence current flow path between the outlet 30 and the plug 18, so that the plug 18 can draw current relatively freely from the outlet 30. The receiving socket 95 preferably includes a hot prong slot 96, a common prong slot 98, and a ground prong slot 100 configured to receive standard hot, common, and ground prongs in electrical communication with the hot, common, and ground prongs 46, 48, 50 within the core 40.

The receiving member 44 may have forward tabs 102 comprising edges 103 arranged perpendicular to the main body of the receiving member 44. Preferably, two forward tabs 102 are provided on opposite sides of the receiving member 44 in the transverse direction 24 (only one of the forward tabs 102 is visible in FIG. 2). Similarly, a pair of rear tabs 104 may also be provided rearward of the forward tabs 102. The first and second tabs 102, 104 help to orient and retain the core 40 within the housing 38, in a manner that will be described subsequently.

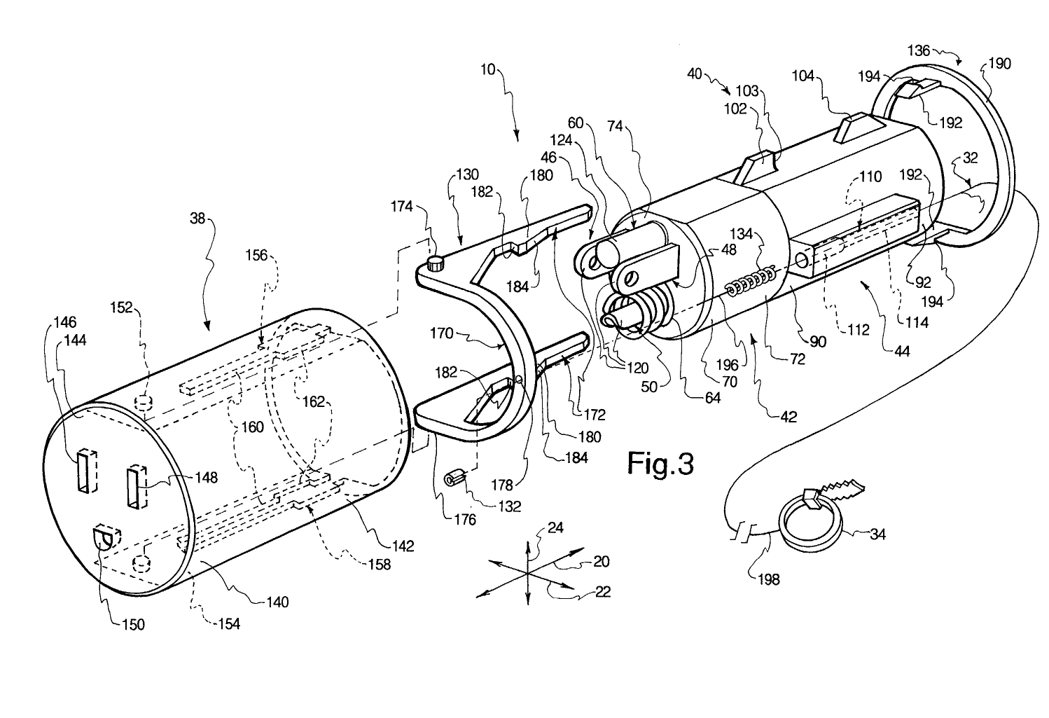

In the embodiment shown in FIG. 2, the receiving member 44 also includes first and second ridges 106, 107 oriented along the length of the receiving member 44 and positioned opposite each other in the lateral direction 22. The ridges 106, 107, if desired, may be dimensioned to engage the interior of the housing 38. Attachment features 108, which may take the form of indentations shaped to receive the perpendicular locking portion 88 in locking engagement, may be provided in the interior of the receiving member 44. The second ridge 107 may have a hole 110, oriented longitudinally, through which the flexible connector 32 passes, as will be described in connection with FIG. 3. The hole 110 preferably has an enlarged portion 112 countersunk against a narrow portion 114.

Each of the prongs 46, 48, 50 may have an extending portion 120 configured to fit within standard slots of the outlet 30, and a receiving portion 122 configured to abut prongs of the plug 18. The extending portions 120 of the prongs 46, 48, and 50 may collectively be referred to as an “electrical contact” because the extending portions 120 interface with the outlet 30 to receive electricity. The hot, common, and ground prongs (not shown) of the plug 18 may extend through the slots 96, 98, 100 in the face 94 of the receiving member 44. The receiving portions 122 may be positioned directly inside the slots 96, 98, and 100, and may be bent or curved such that the prongs of the plug 18 slide along and deflect the receiving portions122. The resilient force of the prongs 46, 48, 50 then serves to maintain a secure electrical connection between the prongs of the plug 18, and the prongs 46, 48, 50 of the core 40.

Optionally, the ground prong 50, ground prong slot 80, and the ground prong slot 100 may be omitted to adapt the apparatus to outlets that are not configured to receive a ground prong. Many older outlets, for example, receive only hot and common prongs. The prongs 46, 48, 50 may be configured in a wide variety of other ways as well, such as with a U.S. 220 Volt prong configuration, of a type used for heavier machinery and appliances. Alternatively, foreign prong configurations may be used. If necessary, additional prongs may be utilized to adapt the apparatus 10 to use with three phase power outlets or the like.

The nonconductive member 60 may have any number of configurations suitable for exerting pressure outward from the face 74 without conducting electricity between the hot and common prongs 46, 48. As shown, the nonconductive member 60 has a narrow portion 124 sized to fit through the hole 82 with clearance, and an enlarged portion 126 too large to fit into the hole 82, so that the nonconductive member 60 is unable to pass completely through the hole 82 and out of the core 40. The enlarged portion 126 may be hollow with an inside diameter large enough to fit over a portion of the first spring 62 to keep the first spring 62 properly centered within the hole 82. The first and second springs 62, 64 need not be linear coil springs as depicted in FIG. 2, but may be torsional springs, angular springs, leaf springs, or any other suitable type of resilient member. Compressed gas cylinders and the like may also be utilized in place of the springs 62, 64, if desired.

Assembly of the core 40 may be accomplished quickly and easily, either manually or by a mechanized process. The prongs 46, 48, 50 and the nonconductive member 60 may first be inserted into the slots 76, 78, 80 and the hole 82, respectively, in a longitudinal direction 20. The prongs 46, 48, and 50 may be longitudinally fixed within the cap member 42 by chemical or adhesive bonding, fastening, welding, or any other suitable method. If desired, the cap member 42 may be configured to frictionally engage the prongs 46, 48, 50 to restrain them from motion in the longitudinal direction 20. The nonconductive member 60 should remain free to move in the longitudinal direction 20, except that the enlarged portion 126 cannot pass through the hole 82.

When the prongs 46, 48, 50 and the nonconductive member 60 have been properly positioned and fixed in place, where applicable, the first spring 62 may then be inserted into the enlarged portion 126 of the nonconductive member 60. The receiving member 44 may then be aligned with the cap member 42 and moved in the longitudinal direction 20 such that the receiving portions 122 of the prongs 46, 48, 50 and the first spring 62 pass into the first end 90 of the receiving member 44.

If needed, the prongs 46, 48, 50 and the first spring 62 may be shifted to their appropriate positions within the receiving member 44 such that the receiving portions 122 are properly offset from the slots 96, 98, 100 to contact the prongs of the plug 18 and the first spring 62 is seated within the receiving member 44. The receiving portions 122 may also be fixed within the receiving member 44, if desired, by any suitable method such as chemical or adhesive bonding, welding, fastening, frictional engagement, or the like.

The receiving member 44 may be pushed toward the cap member 42 until the shoulder 86 abuts the receiving member 44, and the attachment features 88 of the cap member 42 engage the attachment features 108 of the receiving member 44. Engagement of the attachment features 88, 108 effectively locks the cap member 42 and the receiving member 44 together so that the core 40 cannot be disassembled to expose a user to electric shock. The second spring 64 may then be inserted into the annular hole 84. The second spring 64 may be left comparatively free of attachment within the annular hole 84, or may be fixed within the annular hole 84 through a method such as chemical or adhesive bonding, welding, fastening, frictional engagement, or the like.

Referring to FIG. 3, an exploded view of the entire apparatus 10, including the core 40 of FIG. 2, in its fully assembled form, is provided. Aside from the housing 38, the apparatus 10 may also have a locking member 130, an anchor 132, a third spring 134, and a locking ring 136, all of which are designed to reside within the housing 38 so that a user cannot interfere with their operation.

The housing 38 may have a first end 140, which will be positioned near the outlet 30 during operation of the apparatus 10, and a second end 142 near the plug 18. A face 144 is formed in the first end 140, and is configured to abut the outlet 30 and against which the core 40 may push away from the outlet 30. The face 144 may be substantially flat and circular in shape, and may have a hot prong slot 146, a common prong slot 148, and a ground prong slot 150 positioned in alignment with the prongs 46, 48, 50 respectively. However, the face 144 is preferably otherwise solid, so that the narrow portion 124 of the nonconductive member 60 and the second spring 64 abut the interior of the face 144 when the core 40 is inserted into the housing 38.

A first recess 152 and a second recess 154 are preferably also formed in the interior of the housing 38 to pivotally receive the locking member 130. In FIG. 3, the locking member 130 is configured as a bracket 130 configured to lock and unlock respective motion of the core 40 and the housing 38 through pivotal motion. However, the locking member 130 may have a number of different configurations suitable for accomplishing the same purpose. For example, the locking member 130 may translate in the longitudinal direction 20 or rotate about the longitudinal axis 20 to lock or unlock the core 38. Alternatively, the locking member 130 could be configured to pivot about the lateral axis 22, instead of the transverse axis 24, as is the case for the bracket 130 of FIG. 3.

The recesses 152, 154 preferably comprise circular indentations, but not through holes, in the outer wall of the housing 38, so that a user is unable to perceive or tamper with the anchoring of the bracket 130. A first slot 156 and a second slot 158 may also be formed inside the housing 38, on opposite sides of the housing 38 in the transverse direction 24. The slots 156, 158 are dimensioned to slidably receive the first and second tabs 102, 104. The slots 156, 158 are of a length sufficient to permit the core 40 to move in the longitudinal direction 20 within the housing 38 to engage and disengage the apparatus 10 from the outlet 30. Each of the slots 156, 158 may have a narrow portion 160 and an enlarged portion 162, for use in conjunction with the locking ring 136.

The bracket 130 locks the core 40 in place within the housing 38, and unlocks the housing 38 when pulled by the flexible connector 32. More specifically, the bracket 130 has an arch portion 170, a pair of transversely spaced tail portions 172, a first button 174, and a second button 176. The arch portion 170 is preferably shaped to fit around the core 40 with clearance. The first and second buttons 174, 176 are sized to fit within the first and second recesses 152, 154 with clearance, so that the bracket 130 can rotate about the transverse axis 24. However, the recesses 152, 154 keep the buttons 174, 176 from moving any of the directions 20, 22, 24. The arch portion 170 may have a hole 178 oriented in the longitudinal direction 20, and aligned with the hole 110 in the second ridge 107 of the receiving member 44.

The tail portions 172 are shaped to interlock with the forward tabs 102 to lock the core 40 in the longitudinal direction 20 within the housing 38. More specifically, each of the tail portions 172 has a tab 180 protruding in the transverse direction 22. Each of the tabs 180 has a perpendicular edge 182 perpendicular to the longitudinal direction 20. When the core 40 is forwardly disposed within the housing 38, such that the prongs 46, 48, 50 protrude from the slots 146, 148, 150 in the housing 38, the tabs 180 are positioned behind the forward tabs 102, and the perpendicular edge 182 of the tabs 180 is pressed against the perpendicular edge 103 of the forward tabs 102 by the force exerted by the springs 62, 64.

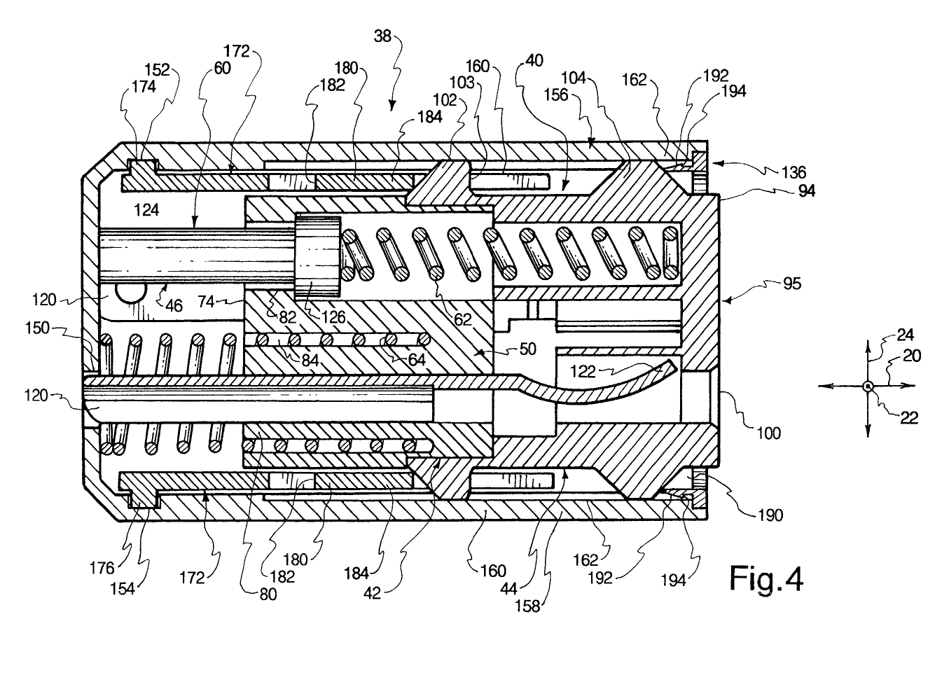

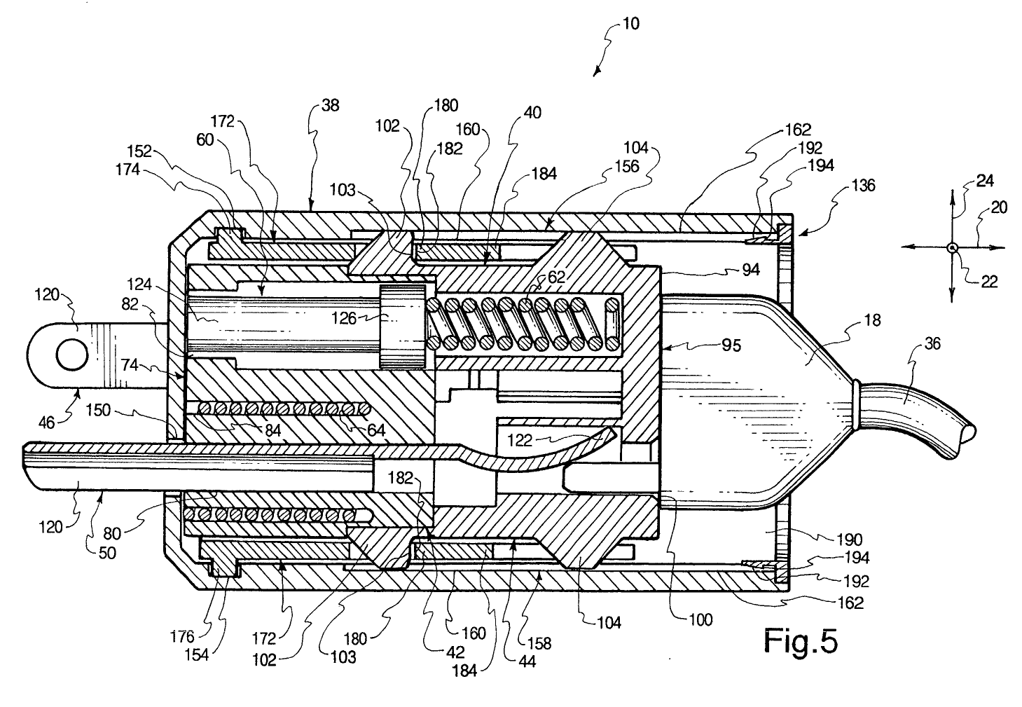

Thus, the bracket 130 holds the prongs 46, 48, 50 in engagement with the outlet 30 until the bracket 130 is pivoted about the buttons 174, 176 to move the tabs 180 out from behind the forward tabs 102 to permit forward motion of the core 40 within the housing 38. The third spring 134 presses against the arch portion 170 to ensure that no rotation of the bracket 130 occurs without a threshold level of tension on the flexible connector 32. Each of the tabs 180 also has a sloping edge 184, shaped in such a way that the forward tabs 102 of the core 40 can move forward against the sloping edges 184 to press the tabs 180 in the lateral direction 22, thereby enabling the forward tabs 102 to slide past the tabs 180 for locking, as will be further described in connection with FIGS. 4 and 5.

The anchor 132 is affixed to the flexible connector 32 and seated against the hole 178, so that the flexible connector 32 is firmly connected to the arch portion 170 of the bracket 130. As depicted in FIG. 3, the anchor 132 comprises a small tube that can be crimped, welded, chemically or adhesively bonded, or otherwise affixed to the flexible connector 32. The anchor 132 is too large to pass through the hole 178, so the flexible connector 32 is affixed to the arch portion 170. The anchor 132 need not be as depicted in FIG. 3, but may take any form suitable for affixing the flexible connector 32 to the arch portion 170. If desired, the anchor 132 and the hole 178 may be omitted in favor of alternative forms of attachment, such as tying the flexible connector to the arch portion 170, or the like.

The locking ring 136 serves to keep the core 40 from sliding rearwardly out of the housing 38. The locking ring 136, in the configuration depicted in FIG. 3, includes a ring portion 190 and a pair of tabs 192 opposite each other in the transverse direction 24. Each of the tabs 192 has a perpendicular edge 194. The tabs 192 may be made narrower than the enlarged portions 162 of the slots, but wider than the narrower portions160. As a result, the tabs 192 can be positioned in the slots 156, 158 such that the perpendicular edges 194 abut the region in which the slots 156, 158 become narrower, thereby locking the tabs 192 in place within the slots 156, 158.

In order to assemble the apparatus 10, the core 40 may first be assembled, as shown and described in connection with FIG. 2. Then, a first end 196 of the flexible connector 32 may be threaded through the hole 110 of the second ridge 107, through the third spring 134, and through the hole 178 of the bracket 130. The first end 196 may then be affixed to the anchor 132.

Then, the bracket 130 may be inserted into the housing 38. Insertion may be accomplished by, for example, manufacturing the housing 38 as two half-tubular sections and positioning the buttons 174, 176 within the recesses 152, 154 prior to permanent attachment of the two half-tubular sections. Alternatively, the bracket 130 may be bent in such a fashion that the arch portion 170 is compressed, and the buttons 174, 176 are brought closer together. The bracket 130 may then be inserted through the open second end 142 of the housing 38, aligned with the recesses 152, 154, and then released to permit the buttons 174, 176 to snap into the recesses 152, 154.

The third spring 134 may then be positioned in the enlarged portion 112 of the hole 110. Then, the core 40 may be aligned with the housing 38 such that the tabs 102, 104 are aligned with the slots 156, 158. Thus, when the core 40 is inserted into the housing 38, the prongs 46, 48, 50 will be aligned with the slots 146, 148, 150, respectively.

After the core 40 is in place within the housing 38, the locking ring 136 may be attached to the housing 38 by first, aligning the tabs 192 with the slots 156, 158 of the housing 38 and then pressing the locking ring 136 into the housing 38 in a longitudinal direction 20, so that the tabs 192 deflect inward, and snap out again when the perpendicular edges 194 of the tabs 192 reach the enlarged portions 162 of the slots 156, 158. Thus, the tabs 102, 104 of the core 40 are precluded from sliding out of the slots 156, 158 by the tabs 192 of the locking ring 136. If desired, the locking ring 136 may have a hole or notch sized to receive the flexible connector 32 as it exits the apparatus 10, to keep the flexible connector 32 from interfering with motion of the core 40.

A second end 198 of the flexible connector 32 may then be affixed to the anchoring device 34 at any time, by the manufacturer or by an end user of the apparatus 10. Similarly, the anchoring device 34 may be attached to the cord 16, as depicted in FIG. 1, by an end user. Thus, the apparatus 10 can be easily retrofitted to an existing electrical device 12, such as the buffer 12 depicted in FIG. 1.

Thus, the flexible connector 32 and the anchor 132 act together to form an actuator for the bracket 130. For purposes of this application, an “actuator” refers to any structure or group of cooperating structures that exerts force on the bracket 130 to permit relative motion between the core 40 and the housing 38. By pulling the arch portion170 to pivot the bracket 130, the flexible connector 32 acts as an actuator for the bracket 130. Those skilled in the art will recognize that many different types of actuators may be used within the scope of the present invention.

Referring to FIG. 4, a cross sectional view of the apparatus 10 depicted in FIGS. 1 through 3, in its fully assembled and uncocked configuration, is provided in order to more clearly depict operation of the apparatus 10. In the uncocked configuration, the housing 38 is in a “disengaging position,” in which the housing 38 is positioned to interfere with engagement of the prongs 46, 48, 50 within the outlet 30. Thus, the prongs 46, 48, 50 are withdrawn somewhat into the housing 38. Preferably, the hot and common prongs 46, 48 do not protrude from the slots 146, 148 so that the apparatus 10 cannot be plugged into the outlet 30 without first cocking it. The ground prong 50, however, may be permitted to protrude from the slot 150 in the uncocked state because no danger of electrocution is posed by the ground prong 50.

In the uncocked state, the first and second springs 62, 64 are in a comparatively relaxed state. If desired, the nonconductive member 60 and the second spring 64 may be contact the housing 38, so that the springs 62, 64 are slightly compressed. The tabs 102, 104 are positioned within the slots 156, 158, rearward of the tabs 180 of the tail portions 172 of the bracket 130. As a result, the forward tabs 102, and therefore the entire core 40, are 8 unrestrained in the longitudinal direction 20 by the bracket 130. The locking ring 136, however, keeps the core 40 from sliding out of the housing 38. The perpendicular edges 194 of the tabs 192 are lodged within the slots 156, 158 so that the locking ring 136 is kept firmly in position, and the rear tabs 104 are unable to move past the tabs 192 in the longitudinal direction 20.

In order to cock the apparatus 10, a user may simply press on the face 94 of the core 40, so that the core 40 slides forward within the housing 38. As the core 44 moves forward, the first and second springs 62, 64 gradually compress, providing an increasing restorative force tending to move the core 40 back out again. Forward motion also causes the forward tabs 102 to slide against the sloping edges 184 of the tabs 180. The tabs 180 are pressed in the lateral direction 22 by the interaction of the forward tabs 102 with the sloping edges 184. As a result, the bracket 130 rotates about the buttons 174, 176 to permit lateral motion of the tabs 180 out of the path of the forward tabs 102.

When the forward tabs 102 have moved past the tabs 180 in the longitudinal direction 180, the forward tabs 102 no longer press the tabs 180 in the lateral direction 22. Thus, the resilient force of the third spring 134 acts on the arch portion 170 to rotate the bracket 130 to move the tabs 180 rearward of the forward tabs 102. When a user ceases to press the core 40 forward, the core 40 will be pressed rearward by the first and second springs 62, 64 until the perpendicular edges 103 of the forward tabs 102 abut the perpendicular edges 182 of the tabs 180. This is the configuration depicted in FIG. 5.

Referring to FIG. 5, the apparatus 10 is depicted in the “cocked” configuration. In the cocked configuration, the housing is in an “engaging position,” to avoid interfering with engagement of the prongs 46, 48, 50 within the outlet 30. The position of the tabs 180 rearward of the forward tabs 102 keeps the forward tabs 102, and therefore the core 40, from moving rearwardly. The core 40 is therefore cocked in a forward position with respect to the housing 38, so that the prongs 46, 48, 50 protrude from the face 144 of the housing 38. The first and second springs 62, 64 are compressed, and thus exert pressure against the housing 38 tending to move the core 40 rearward.

In FIG. 5, the plug 18 is depicted in engagement with the receiving socket 95. The receiving portions 122 of the prongs 46, 48, 50 are deflected by the corresponding prongs of the plug 18, so that electrical contact is constantly maintained between the plug 18 and the prongs 46, 48, 50 of the apparatus 10 (the common prong 48 is not shown in the section view of FIG. 5). The plug 18 may be inserted after the apparatus 10 has been cocked, or may be inserted prior to cocking. If the plug 18 is inserted into the receiving socket 95 before the apparatus 10 is cocked, a user may simply grasp the plug 18 and press forward to effect cocking, in the manner described above. Preferably, the apparatus 10 is cocked prior to engagement of the prongs 46, 48, 50 within the outlet 30.

A user using an electrical device 12, such as the buffer 12 depicted in FIG. 1, may then remotely disengage the apparatus 10, and therefore the plug 18, from the outlet 30 by simply tugging gently on the cord 16. The tension in the cord 16 is transmitted into the flexible connector 32 because the portion 36 of the cord along which the flexible connector 32 is attached is longer than the flexible connector 32. Tension in the flexible connector 32 is transmitted to the anchor 32, which is attached to the first end 196 of the flexible connector 32. The anchor 32 is drawn rearwardly by the flexible connector 32, thereby compressing the third spring 134 and pulling the arch portion 170 of the bracket 130 rearward. The bracket 130 rotates about the buttons 174, 176 so that the tabs 180 move in the lateral direction 22.

When the tension in the flexible connector 32 reaches a threshold level, the bracket 130 rotates far enough to unblock the rearward path of the forward tabs 102. When the bracket 130 blocks the forward tabs 102, the bracket 130 is in the “locked” state. The bracket 130 has reached the “unlocked state” when the tabs 180 have moved far enough to unblock the forward tabs 102.

When the tabs 180 have moved far enough to completely disengage the forward tabs 102, the resilient force of the first and second springs 62, 64 pushes the core 40 rearward with respect to the housing 38, so that the apparatus 10 returns to the configuration depicted in FIG. 4. In doing so, the face 144 of the housing 38 presses against the outlet 30 as the prongs 46, 48, 50 are withdrawn back into the housing 38. The core 40 can be expected to snap backward with considerable speed; consequently, the apparatus 10 may eject itself away from the outlet 30 as much as several inches. In any case the apparatus 10 no longer engages the outlet 30, so that a user located at the buffer 12 may simply reel in the cord 16 to retrieve the apparatus 10 from the outlet 30. A user may then repeat the procedure for cocking the apparatus 10 to prepare it for engagement in a different electrical outlet.

The apparatus 10 of FIGS. 1 through 5 is mechanically triggered because the tension of the flexible connector 32 is what triggers disengagement of the apparatus 10 from the outlet 30. The invention also contemplates other types of mechanical triggering, besides transmission of tension through the cord 16, such as transmission of vibration attuned to a selected frequency, transmission of air pressure, or transmission of a wave through the cord 16 by moving the cord 16 in whiplike fashion.

The use of the flexible connector 32, as described, is beneficial, in part because the cord 16 can be pulled from any direction with respect to the apparatus 10. Triggering of the apparatus 10 is substantially independent of the rotational orientation of the cord 16 with respect to the apparatus 10 because a user need not pull the cord 16 to one side or the other, or to a position straight outward from the apparatus 10, to trigger disengagement of the apparatus 10 from the outlet 30.

In the configuration depicted in FIGS. 1 through 5, the apparatus 10 guards against accidental damage to the cord 16 by bending or pulling when a user reaches the full extent of the cord 16. Since the apparatus 10 is actuated by tension in the cord, when a user reaches the extent of the cord 16, the apparatus 10 is triggered to disengage from the outlet 30 before enough tension or bending is applied to the cord 16 to cause damage.

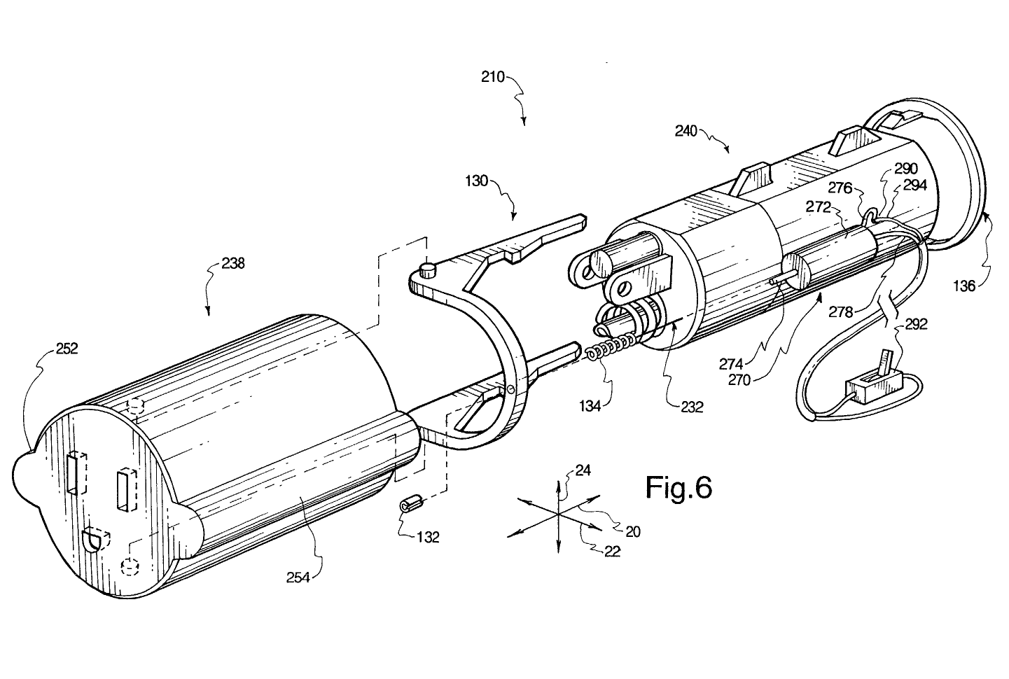

As mentioned, many different types of actuator besides the flexible connector 32 may be used. Additionally, several types of electrical triggering are envisioned within the scope of the invention. Some examples of electrically triggered remote unplugging devices are depicted in connection with FIGS. 6 through 9, and will be described presently.

Referring to FIG. 6, one electrically triggered embodiment of an apparatus 210 according to the invention is depicted. As shown, the apparatus 210 has a bracket 130, anchor 132, third spring 134, and locking ring 136 configured substantially the same as the bracket 130, anchor 132, third spring 134, and locking ring 136 described in connection with FIGS. 1 through 5. Additionally, the apparatus 210 has a flexible connector 232, pressure member 238, or housing 238, and connection member 240, or core 240 configured somewhat differently than the flexible connector 32, housing 38, and core 40.

More specifically, the housing 238 has a first lateral cavity 252 and a second lateral cavity 254, each of which is roughly semi-cylindrical in shape, as depicted. The core 240 has no lateral features like the first and second ridges 106, 107 of the core 40. The flexible connector 232 is attached to the bracket 130 by operation of the anchor 132, as with FIGS. 1 through 5. However, instead of extending out of the apparatus 10 to attach to the cord 16, the flexible connector 232 is simply attached to a solenoid 270 beside the core 240. In the alternative, the flexible connector 232 and anchor 132 may be omitted, and the solenoid 270 may be connected directly to the bracket 130, if desired.

Generally, a solenoid is a device utilizing the magnetic fields developed by electrical currents to move a magnetically susceptible part, such as an iron core or plunger. Typically, wire coils are used to produce a concerted magnetic field in a desired direction. In a rotary solenoid, the magnetic fields induce rotation of the plunger. In a linear solenoid, a uniform, linear magnetic field is produced to obtain linear motion of the core. Linear solenoids may be “push” type solenoids, in which activation of the solenoid pushes the plunger out from the main body of the solenoid, or “pull” type solenoids, in which the plunger is drawn into the main body of the solenoid.

The solenoid 270 of FIG. 6 is preferably a “pull” type solenoid with a body 272 and plunger 274. Activation of the solenoid 270 pulls the plunger 272 into the body 274 of the solenoid 270. Thus, the solenoid 270 produces tension in the flexible connector 232 to rotate the bracket 130. As with the previous embodiment, the third spring 134 exerts pressure on the bracket 130 to keep the bracket 130 from rotating in the absence of tension on the flexible connector 232.

The solenoid 270 receives electrical power from a hot wire 276 and a first common wire 278. The hot wire 276 travels through a hole 290 in the outer wall of the core 240 to connect directly to the hot prong 46 inside the core 240. The first common wire 278 extends out of the apparatus 210 to a switch 292 at a remote location with respect to the apparatus 210. In the context of this application, a “remote location” refers to any location from which a person cannot physically reach the apparatus 210.

A second common wire 294 runs from the common prong 48 within the core 240, through the hole 290, and to the switch 292. The switch 292 can be any of a number of types known in the art, that can be easily moved between a fully-open state and a fully-closed state. Rocker-switches, toggling buttons, sliding switches, and the like are a few examples of mechanisms that may be used to form the switch 292.

Thus, when the switch 292 is activated, the first and second common wires 278, 294 are electrically connected, and the wires 276, 278, 294 form a complete circuit to deliver power to the solenoid 270. The solenoid 270 may be configured to operate on DC power, and may require a different input voltage than the unmodified voltage of the outlet 30. Thus, an AC/DC converter, a transformer, or other signal modification circuitry (not shown) may be housed within the solenoid 270 or the core 240 to provide the proper type of power to the coils (not shown) of the solenoid 270.

The apparatus 210 may be assembled in much the same way as the apparatus 10. The flexible connector 232 may first be attached to the bracket 130 with the anchor 132. Then, the flexible connector 232 may be threaded through the third spring 134 and attached to the plunger 274 of the solenoid 270. Preferably, the solenoid 270 is not affixed to the core 240. Rather, when the bracket 130 is installed in the housing 238 with the third spring 134 and the flexible connector 232, the solenoid 270 may also be inserted into the housing 238 and affixed to the housing 238, within the second lateral cavity 254. The solenoid 270 may be positioned in the longitudinal direction 20 such that the third spring 134 encircles the plunger 274 and abuts the bracket 130 and the main body 272 of the solenoid 270.

Thus, the solenoid 270, flexible connector 232, and anchor 132 of the embodiment of FIG. 6 cooperate to act as an actuator to perform the same function as that carried out by the flexible connector 32 and anchor 132 of FIGS. 1 through 5. However, in contrast to the purely mechanical actuation of FIGS. 1 through 5, the solenoid 270 enables actuation of the bracket 130 to occur based on an electrical input, or electrical trigger.

The core 240 may be inserted into the housing 238 in much the same fashion as the installation of the core 40 of FIGS. 1 through 5 in the housing 38. If desired, each of the wires 276, 278 may have two separate lengths connected by a connector (not shown), so that the solenoid 270 can be installed into the housing 238 without interference from the core 240. The wires 276, 278 may then be connected after the core 240 has been at least partially positioned within the housing 238.

When the core 240 is in place within the housing 238, the locking ring 136 may be installed as described in connection with the previous embodiment. The locking ring 136 may have a hole or notch to receive the wires 278, 294, to keep the wires 278, 294 from interfering with motion of the core 240. Preferably, the wires 276, 278 have some slack 8 within the housing 238, so that the core 240 can move with respect to the solenoid 270, between the cocked and uncocked positions, without placing significant tension on the wires 276, 278.

Preferably, the switch 292 is located at the electrical device 12, or the buffer 12 depicted in FIG. 1. The switch 292 may, for example, be mounted on the buffer 12, or may be carried by a user with a belt clip, holster, or other convenient attachment. Thus, a user may toggle the switch 292 to activate the apparatus 210 without leaving the electrical device 12. If desired, the common wires 278, 294 may be attached together along their length, or may be threaded through a common insulative sleeve. The wires 278, 294 may then be wrapped around the cord 16, or attached to the cord 16 periodically, so that the user need not be troubled with any additional, separate wiring from the apparatus 210 to the buffer 12.

Preferably, the apparatus 210 is easily retrofitted to an existing plug 18 and cord 16. Thus, the wires 278, 294 may be sold with attachment fixtures such as hook-and-loop style attachments, adhesives, clamps, clips, or other fastening devices, so that a user can easily attach the wires 278, 294 to the cord 16, and then remove them for use with a different electrical device. Similarly, the switch 292 may be provided with an attachment fixture similar to those mentioned above, so that the switch 292 can be removably, yet securely mounted to the electrical device 12.

Although the apparatus 210 is not difficult for an end user to retrofit, there may be significant benefits to a remote unplugging apparatus that does not require any type of wiring between the switch and the main body of the apparatus. Such a wireless apparatus could be moved from one device to another without the necessity of moving any wiring, besides the cord 16.

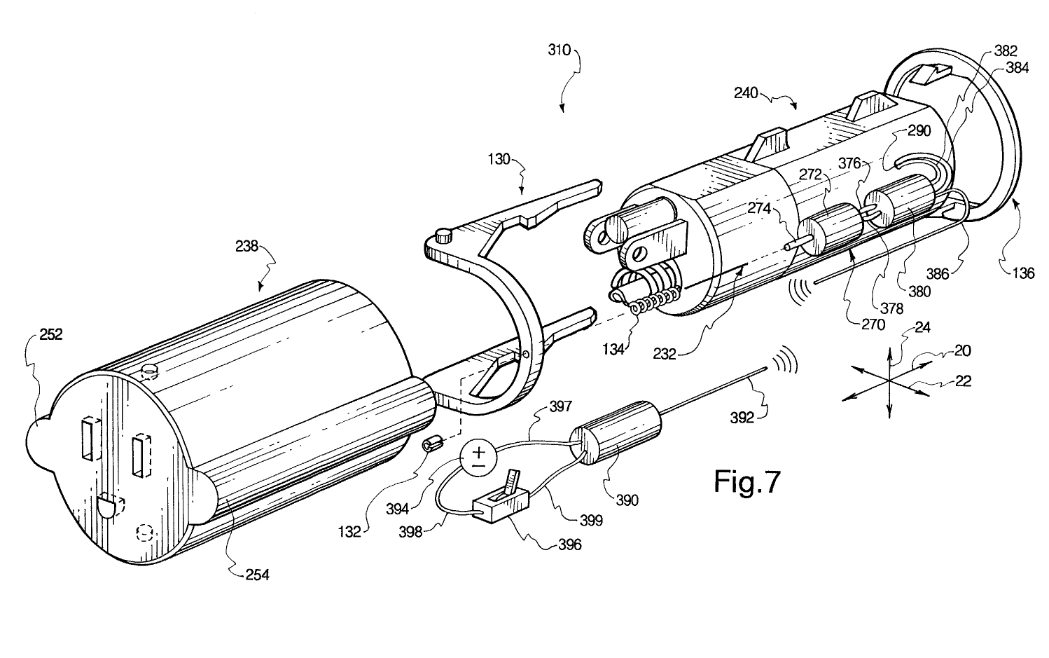

Referring to FIG. 7, one example of an electrically triggered, wireless apparatus 310 according to the present invention is depicted. The apparatus 310 may have a core 240, a housing 238, a bracket 130, an anchor 132, a third spring 134, a snap ring 136, a flexible connector 232, and a solenoid 270 similar to those described in connection with FIG. 6. However, rather than being connected to a switch or to the prongs 46, 48, the solenoid 270 may have a hot wire 376 and a common wire 378 extending from a receiver 380 to provide power to the solenoid 270. Those of skill in the art will recognize that the receiver 380 may have any known configuration suitable for transforming an electromagnetic signal into an electrical signal.

The receiver 380 may, in turn, receive electrical power via a hot wire 382 and a common wire 384, extending into the core 240 through the hole 290 to connect to the hot prong 46 and the common prong 48, respectively. Thus, the receiver 380 receives power from the outlet 30. Additionally, the receiver 380 may have an antenna 386 designed to receive electromagnetic signals. The antenna 386 may be linear as depicted, or may be circular or otherwise shaped to receive the type of signal used. Preferably, the receiver 380 is configured to receive a radio band signal of a bandwidth authorized by the FCC for home use. However, the invention contemplates the use of any type of electromagnetic signal.

Additionally, the receiver 380 may be configured to recognize a comparatively simple analog signal. Alternatively, the receiver 380 may have the circuitry required to receive and process a digital signal. Digital signals may advantageously be used to avoid interference from unrelated devices transmitting along a similar bandwidth, or to decrease the threshold signal amplitude required to overcome background noise. The receiver 380 may also be configured to receive and process other commands, besides an unplugging command, via a digital or analog signal. For example, the receiver 380 may receive instructions to unplug the apparatus 310 after a certain period of time has elapsed, after the current through the apparatus 310 has reached an upper or lower limit, or when any other triggering event has occurred.

The various components of the apparatus 310 may be assembled in much the same way as described in connection with the apparatus 210 described previously. However, in the case of the apparatus 310, the receiver 380 and the antenna 386 may be installed within the second lateral cavity 254, along with the solenoid 270. Alternatively, if there is not sufficient room in the second lateral cavity 254 to accommodate the receiver 380 and the antenna 386 as well as the solenoid 270, the receiver 380 and the antenna 386 may be installed within the first lateral cavity 252. In such a case, the wires 376, 378 may be made long enough to circumnavigate the core 240. In either configuration, the receiver 380 and the antenna 386 are preferably affixed to the interior of the housing 238. Thus, the wires 382, 384 preferably have enough play to permit motion of the core 240 between the cocked and uncocked positions.

The wireless signal is provided by a transmitter 390 positioned at a remote location. The transmitter 390 may have an antenna 392 configured to transmit the signal over a suitable distance, i.e., a distance at least as long as the cord 16. The transmitter 390 may take any form suitable for creating a consistent electromagnetic signal. Like the antenna 386 of the receiver 380, the antenna 392 may be straight, circular, or otherwise shaped, as required by the type of signal to be transmitted. A power source 394 may provide electrical power for the transmitter 390, subject to the operation of a switch 396. The power source 394 may simply comprise a connection to the cord 16, so that the transmitter 390 is driven by power delivered through the apparatus 310. Alternatively, the power source 394 may be self-contained, such as one or more batteries.

The power source 394 may have a wire 397 extending directly to the transmitter 390, and a wire 398 extending to the switch 396. Another wire 399 travels from the switch 396 to the transmitter 390. Thus, when a user activates the switch 396, a complete circuit is formed between the power source 394 and the transmitter 390, so that the signal is transmitted through the antenna 392. The power source 394, switch 386, transmitter 390, antenna 392, and wires 397, 398, 399 may all be housed within a case to form a compact unit that can be removably attached to the electrical device 12, or carried on the person of a user.

After the signal is transmitted, it is received through the antenna 386 and processed by the receiver 380. When the receiver 380 receives the signal, the receiver 380 permits passthrough of current from the prongs 46, 48 through the wires 382, 384, 376, and 378 to the solenoid 270 to draw the plunger 274. If the signal is digital, the receiver 380 may first decode the signal prior to activation of the solenoid 270. Similar to the previous embodiment, conditioning of the signal for use by the solenoid 270 may be carried out by circuitry located within the body 272 of the solenoid, within the core 240, or even within the receiver 380. Once the plunger 274 is actuated, the apparatus 310 unplugs itself from the outlet 30 in the same manner as the apparatus 210 described in connection with FIG. 6.

An unplugging apparatus according to the invention may also be adapted in a number of ways to enhance the safety, durability, and functionality of the unplugging apparatus. For example, various features may be added to ensure that the solenoid 270 only operates for as long as necessary. Other features may be utilized to trigger automatic unplugging when the current drawn by the electrical device 12 departs from the desired operating current.

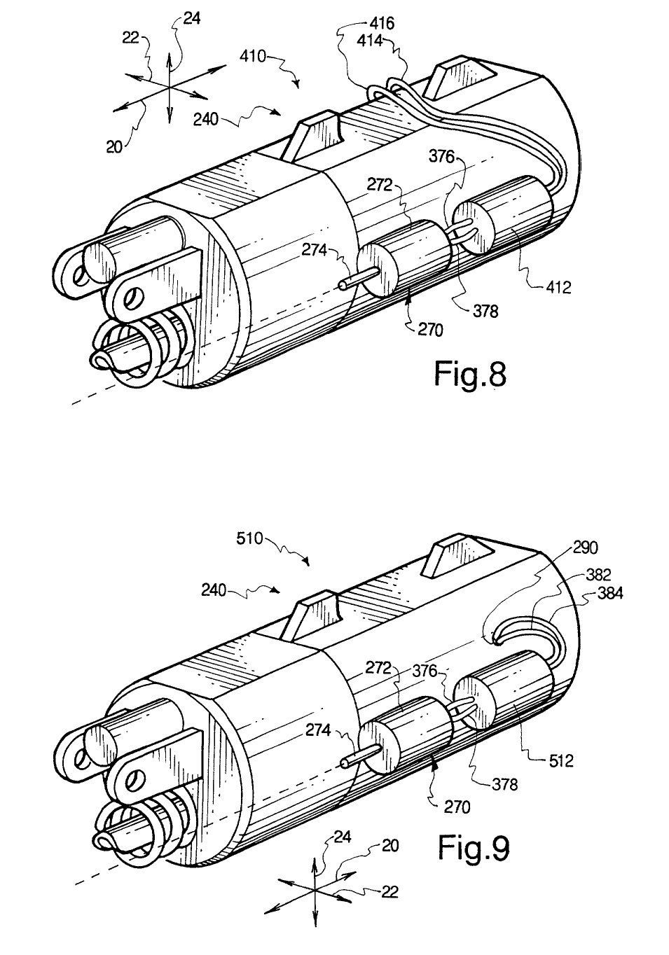

Referring to FIG. 8, a selected portion of one possible embodiment of an apparatus 410 having an enhanced, capacitor-based power source for the solenoid 270, is depicted. The apparatus 410 of FIG. 8 may be triggered in the same fashion as any of the previous embodiments. Thus, the housing 238, bracket 130, anchor 132, third spring 134, and locking ring 136 (not shown) may also be as shown and described in connection with FIGS. 6 and 7, or in connection with FIGS. 1-5. The core 240 may be slightly modified to position the hole 290 (not shown in FIG. 8) at a different location if desired.

The apparatus 410 of FIG. 8 may have a capacitor 412 interposed between the prongs 46, 48 and the solenoid 270. The capacitor 412 serves to store electric potential to drive the solenoid 270. During use of the electrical device 12, as electrical current flows through the apparatus 410, some of the electricity is shunted into the capacitor 412 and stored. Then, when the solenoid 270 is activated, the capacitor 412 discharges comparatively rapidly.

The rapid discharge of the capacitor 412 serves two major functions: it increases the impulse force exerted by the plunger 274 to ensure that the force is sufficient to rotate the bracket 130 enough to unlock the core 240, and it limits the duration of operation of the solenoid 270 to ensure that the solenoid 270 does not operate longer than necessary. Limiting the duration of operation of the solenoid 270 is advantageous because, if the solenoid 270 is exposed to high current over a long period of time, heat may build up in the solenoid 270, causing the coils to fuse together, or otherwise damaging the solenoid 270. Thus, in the event that the apparatus 410 does not fully disengage from the outlet 30, limiting the current available to the solenoid 270 decreases the likelihood that the apparatus 410 will be damaged, or cause damage to any other heat-sensitive items in the vicinity of the outlet 30.

In the alternative, the apparatus 410 may otherwise be configured to entirely cut off power to the solenoid 270 when the apparatus 410 has become partially disengaged from the outlet 30. This may be accomplished by, for example, routing power from the prongs 46, 48 through the forward tabs 102 or the rear tabs 104, through conductive strips (not shown) inside the slots 156, 158 that are only long enough to connect to the tabs 102 or 104 when the core 240 is forwardly located with respect to the housing 238. The solenoid 270 may then receive power through the conductive strips. Thus, no power is transmitted to the solenoid 270 when the core 240 has moved a selected distance rearward with respect to the core 238.

Wires 414, 416 may connect the capacitor 412 to a receiver 380, a switch 292, the prongs 46, 48, or some combination thereof, as described in connection with FIGS. 1 through 7. Other components outside the core 240, such as a receiver 380 or the like, may be positioned on the opposite side of the core 240 from the solenoid 270 and capacitor 412, 8 so that they can be installed within the first lateral cavity 252 of the housing 238. Thus, the wires 414, 416 are shown circumnavigating the core 240. However, the capacitor 412 need not be positioned or connected as shown, but may be located in the first lateral cavity 252, within the core 240, or at any other desirable location.

Assembly of the apparatus 410 may be carried out in much the same fashion as the apparatus 310 of FIG. 7 or the apparatus 210 of FIG. 8. Similarly, disengagement of the apparatus 410 from the outlet 30 may be effected by a user in much the same way as described in connection with FIGS. 6 and 7.

Referring to FIG. 9, yet another embodiment of a remote unplugging apparatus is depicted. More specifically, an apparatus 510 may be triggered, at least in part, through detection of the electrical signal through the apparatus 510. Thus, the apparatus 510 may have a sensor 512 configured to read the electrical signal through the prongs 46, 48 and trigger the apparatus 510 accordingly. For example, the sensor 512 may be configured as a current measurement device 512, such as an ammeter, that operates to measure the current through the prongs 46, 48. The current measurement device 512 may receive and detect the signal from the prongs 46, 48 through wires 382, 384, and may be connected to provide power to the solenoid 270 via wires 376, 378.

The current measurement device 512 may operate in a number of different ways. For example, through the use of the current measurement device 512, the apparatus 510 may act as a circuit breaker. The current measurement device 512 may thus be configured to provide pass-through electrical power to the solenoid 270 when the current through the prongs 46, 48 exceeds a preset limit. The limit may be hard-wired into the current measurement device 512, or may be user-selectable.

For example, if the electrical device 12 is to operate at a maximum of 25 Amperes, but is to be used on a circuit for which the breaker is set to 50 Amperes, it may be desirable to have a device-specific circuit breaker. The current measurement device 512 may be set to trigger disengagement of the apparatus 510 from the outlet 30 when the current through the apparatus 510 exceeds 25 Amperes. Then, the remainder of the circuit remains open to power between 25 and 50 Amperes, but the electrical device 12 will not receive more than 25 Amperes.

Alternatively, the current measurement device 512 may operate as a surge/spike detector. Thus, the current measurement device may be configured to trigger disengagement of the apparatus 510 from the outlet 30 when an unusually high current, or an unusually rapid increase in the current is detected in the prongs 46, 48. Similarly, if the electrical device 12 is of a type that may be damaged by operation at low currents, the current measurement device 512 may be configured to disengage the apparatus 510 when the current through the apparatus 510 drops below a lower limit.

Consequently, the apparatus 510 may be configured to protect the electrical device 12 against lightning strikes, brownouts, or other potentially damaging and dangerous events. Unplugging of the apparatus 510 provides significantly more protection than surge protectors that simply open an internal switch, because after the apparatus 510 has ejected from the outlet 30, a substantial air gap exists between the prongs 46, 48 and the outlet 30 to prevent arcing.

As yet another alternative, the current measurement device 512 may be configured to provide a method of remotely disengaging the apparatus 510 from the outlet 310. More specifically, the current measurement device 512 may operate to measure increases and decreases in the current through the apparatus 510, and trigger disengagement when a specified number of increases and decreases occur in rapid succession. For example, the current measurement device 512 may be configured to trigger disengagement when a user flips the power switch of the electrical device 12 off, on, and off again within a span of a few seconds. In this way, the apparatus 510 may be disengaged from the outlet 30 simply by using the power switch 14 of the electrical device 12. Such a configuration makes retrofitting an existing electrical device 12 for use with the apparatus 510 exceptionally easy because no remote switches need be installed or carried by the user.

The apparatus 510 may be assembled in much the same fashion as those previously described. The current measurement device 512 need not be positioned or connected as depicted in FIG. 9, but may be provided at any suitable location, such as in the first lateral cavity 252 of the housing 238, within the core 240, or a similar location.

The current measurement device 512 need not provide the only method by which the apparatus 510 can be triggered. Any user-operable triggering devices, such as the transmitter and receiver 390, 380 of FIG. 7, or the switch 292 of FIG. 6, may be connected in cooperation with the current measurement device 512 so that the apparatus 510 can be triggered either by the user, or by the current measurement device 512. Accordingly, the apparatus 510 may be configured to provide several different benefits.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

We claim:

1. An apparatus configured to selectively disengage an electric plug from an outlet, the electric plug being connected to an electrical device by a cord, wherein the apparatus comprises:
a substantially rigid connection member, the connection member having a first end and a second end opposite the first end;
an electrical contact mounted proximate the first end, the electrical contact being configured to engage an outlet to receive electric current;
a receiving socket formed in the connection member, the receiving socket being configured to receive the electric plug and to convey the electric current from the electrical contact to the electric plug; and
a pressure member configured to be selectively movable with respect to the electrical contact between an engaging position and a disengaging position, the pressure member acting to remove the electrical contact from the outlet as the pressure member moves into the disengaging position, wherein movement of the pressure member is controllable from a location remote from the apparatus.

2. The apparatus of claim 1, further comprising a resilient member configured to urge the pressure member into the disengaging position.

3. The apparatus of claim 2, further comprising a locking member configured to restrict motion of the resilient member, the locking member operating to selectively release the resilient member to disengage the electrical contact from the outlet.

4. The apparatus of claim 3, further comprising an actuator positioned proximate the locking member, the actuator being configured to unlock the locking member.

5. The apparatus of claim 4, wherein the actuator comprises a flexible connector attached to the locking member and to the cord, wherein tension in the cord induces tension in the flexible connector, a threshold level of tension in the flexible connector operating to unlock the locking member.

6. The apparatus of claim 5, wherein the flexible connector has a length that is shorter than the portion of the cord between the point at which the flexible connector is attached to the cord and the electric plug.

7. The apparatus of claim 4, wherein the actuator comprises a solenoid powered by electric current from the outlet, the solenoid operating to selectively unlock the locking member.

8. The apparatus of claim 7, further comprising a switch positioned at the remote location to control the solenoid.

9. The apparatus of claim 8, further comprising a wire connected between the solenoid and the switch, the wire being attachable to the cord.

10. The apparatus of claim 8, further comprising:
a transmitter connected to the switch and configured to emit an electromagnetic signal when activated by the switch; and
a receiver connected to the solenoid, the receiver being configured to receive the electromagnetic signal and to activate the solenoid upon receipt of the electromagnetic signal.

11. The apparatus of claim 10, wherein the electromagnetic signal comprises an analog signal having a radio band frequency.

12. The apparatus of claim 10, wherein the electromagnetic signal comprises a digital signal.

13. The apparatus of claim 7, wherein the solenoid is configured to deactivate when the electrical contact has been partially removed from the outlet.

14. The apparatus of claim 7, further comprising a capacitor configured to store a quantity of electrical potential sufficient to power the solenoid to remove the electrical contact from the outlet.

15. The apparatus of claim 1, wherein control of the pressure member is substantially independent of a rotational orientation of the cord with respect to the apparatus.

16. The apparatus of claim 1, further comprising a current measurement device configured to measure electrical current through the apparatus.

17. The apparatus of claim 16, wherein the current measurement device is further configured to activate the pressure member when the current reaches a predetermined limit.

18. The apparatus of claim 16, wherein the current measurement device is further configured to activate the pressure member when the current drops and rises in quick succession so that the electric plug is disengaged when a user turns the device off and on in quick succession.

19. An apparatus configured to disengage from an outlet upon receipt of a wireless signal, the apparatus comprising:
a connection member having a first end;
an electrical contact disposed proximate the first end of the connection member, the electrical contact being configured to engage an outlet to receive electric current;
a pressure member configured to be selectively movable with respect to the connection member between an engaging position and a disengaging position, the pressure member acting to remove the electrical contact from the outlet to the disengaging position; and
a receiver configured to receive a wireless signal, the receiver activating movement of the pressure member when the wireless signal is received.

20. The apparatus of claim 19, further comprising a receiving socket formed in the connection member and in electrical communication with the electrical contact, the receiving socket being configured to receive an electric plug connected to an electrical device by a cord.

21. The apparatus of claim 20, wherein the connection member is substantially rigid.

22. The apparatus of claim 19, wherein the wireless signal is received from a transmitter disposed proximate an electrical device disposed remote from the apparatus.

23. The apparatus of claim 22, wherein the wireless signal comprises a radio frequency analog signal.

24. The apparatus of claim 22, wherein the wireless signal comprises a digital signal.

25. An apparatus configured to selectively disengage an electric plug from an outlet, the electric plug being connected to an electrical device by a cord, wherein the apparatus comprises:
a connection member having a first end;
an electrical contact disposed proximate the first end of the connection member, the electrical contact being configured to engage an outlet to receive electric current;
a pressure member configured to be selectively movable with respect to the connection member between an engaging position and a disengaging position, the pressure member acting to remove the electrical contact from the outlet to the disengaging position; and
a flexible connector attached to the cord such that tension on the cord is transmitted to the flexible connector, wherein the flexible connector is operatively connected to the pressure member such that a threshold level of tension in the flexible connector in substantially any direction outward from the outlet activates the pressure member to disengage the electrical contact from the outlet.

26. The apparatus of claim 25, further comprising:
a resilient member configured to urge the pressure member into the disengaging position; and
a locking member configured to restrict motion of the resilient member, the locking member operating to selectively permit the resilient member to disengage the electrical contact from the outlet.

27. The apparatus of claim 26, wherein the flexible connector is anchored to the locking member such that tension on the flexible connector urges the locking member to permit the resilient member to disengage the electrical contact from the outlet.

28. The apparatus of claim 27, further comprising a receiving socket formed in the connection member to receive the electric plug so that the electric plug engages the electric contact to receive electric current.

29. A method for remotely disengaging an electric plug from an outlet, the electric plug being connected to an electrical device by a cord, the method comprising:
plugging the electric plug into a receiving socket of an apparatus, the apparatus having a substantially rigid connection member and a pressure member movable with respect to the connection member, wherein the receiving socket is formed in the connection member;
cocking the apparatus to extend an electrical contact;
plugging the electrical contact into an outlet; and
remotely activating the apparatus to withdraw the electrical contact from the outlet.

30. The method of claim 29, wherein activating the pressure member comprises unlocking a locking member to permit a resilient member located proximate the pressure member to urge the connection member away from the outlet.

31. The method of claim 30, wherein activating the pressure member further comprises manually pulling on the cord to pull a flexible connector connected to the locking member.

32. The method of claim 30, wherein activating the pressure member further comprises activating a solenoid operably connected to the locking member.

33. The method of claim 32, wherein activating the solenoid further comprises actuating a switch at the location remote from the apparatus.

34. The method of claim 33, wherein the switch is connected to the solenoid by a wire configured to provide electrical power to the solenoid.

35. The method of claim 33, wherein the switch is connected to a transmitter, the transmitter being configured to wirelessly transmit a signal to a receiver connected to the solenoid.
